(19) United States
(12) Patent Application Publication
(10) Pub. No.: US 2002/0196632 A1
(43) Pub. Date: Dec. 26, 2002

(54) Glass fitter for lighting fixtures

(76) Inventor: Arch. Riccardo Luchi, Firenze (IT)

Correspondence Address: HILL & HUNN, LLP, Suite 1440, 201 Main Street, Fort Worth, TX, 76102, US

(21) Appl. No.: 09/885,904

(22) Filed: Jun. 20, 2001

(51) Int. Cl. F21V 11/00

(52) U.S. Cl. 362/353; 362/343; 362/257; 362/351; 362/361; 362/414; 362/439; 362/410

(57) ABSTRACT

A fitter for a lighting fixture is provided that is made primarily from glass, plastic, or a similar material. The novel fitter design is affixed to the lighting fixture near a socket, and is used to hold in place a removable shade. The shade may rest in the novel fitter, or may be removably attached to it using mechanical attachment means.

### BACKGROUND OF THE INVENTION

1. Field of the Invention

The present application relates generally to lighting fixtures, and more specifically to elements used to retain glass shades in place on lighting fixtures.

2. Description of the Prior Art

Electric lighting fixtures are available in a large variety of designs. Many designs have a number of similarities, because of their function. For example, fixtures must include one or more sockets for a light bulb to be connected. In many commonly available fixtures the socket is sized to fit a standard sized bulb, which may come in various wattages. Others utilize specialty bulbs having various sizes and shapes.

Many fixture designs include a shade of some type to cover the bulb and socket. One design of such shade is to provide a glass, plastic, or similar material shade that is a little larger than the bulb, and that mounts on or near the socket. Such shades can be clear, translucent, colored, or patterned. They may also be sculpted to any of a number of aesthetically pleasing shapes.

When glass and similar shades are used, provision must be made for holding the shade in position. Often, a fitter is provided for this purpose. The fitter is more or less permanently attached to the fixture, in fixed relationship to the socket. The shade is removable, and attached to the fitter. The fitter performs the function of holding the shade in place, and provides an important secondary function of adding an attractive and aesthetically pleasing look to the fixture.

Heretofore, fitters used with lighting fixtures have been made from the same material as the fixture itself, or a similar material. For example, fitters are often made from brass or a similar metal having a finish compatible with the fixture itself. They may also be made from plastic, or similar rigid material. Fitters known in the prior art have been made from opaque materials such as those listed, and their design and use has become well know in the art.

It would be desirable to provide a fitter for a lighting fixture that utilized a novel construction, thereby providing a different style and look for lighting fixtures. It would be desirable for such a novel fitter design to be generally compatible with available lighting fixture designs.

### SUMMARY OF THE INVENTION

In accordance with the present invention, a fitter for a lighting fixture is provided that is made primarily from glass, plastic, or a similar material. The novel fitter design is affixed to the lighting fixture near a socket, and is used to hold in place a removable shade. The shade may rest in the novel fitter, or may be removably attached to it using mechanical attachment means.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a view of a part of a lighting fixture utilizing a fitter in accordance with the present invention;

FIG. 2 is a view of a portion of FIG. 1, illustrating attachment of a preferred fitter in accordance with a first embodiment of the invention;

FIG. 3 is a view illustrating attachment of a preferred fitter in accordance with a second embodiment of the invention; and

FIG. 4 is a view illustrating attachment of a shade to the fitter of the second embodiment shown in FIG. 3.

### DESCRIPTION OF THE PREFERRED EMBODIMENT

In the following description, the improved lighting fixture fitter will generally be referred to as a glass fitter. This will be understood by those skilled in the art from the following description as including fitters made of materials other than glass, such as plastic, acrylic, and similar materials. The novel fitter is intended to provide an aesthetic look different from those previously available by providing a material for the fitter that differs from that used in the fixture itself. This generally requires that the fitter be separately attached to the fixture, rather than being formed integrally therewith.

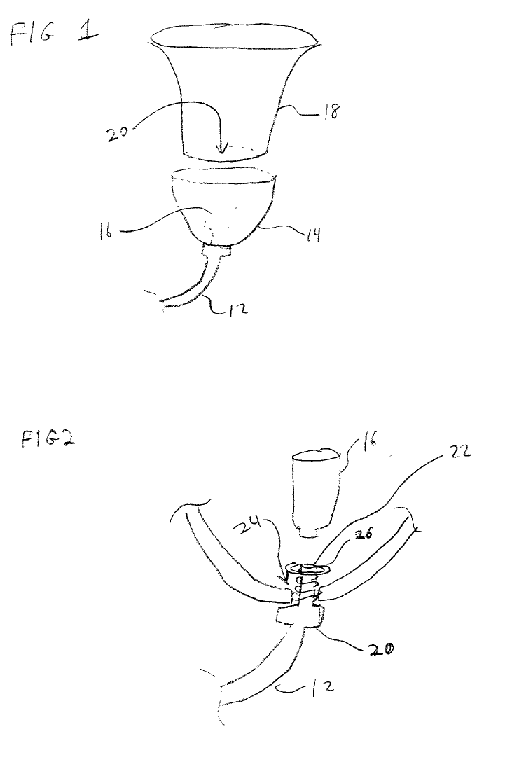

FIG. 1 shows a portion of a lighting fixture including a single bulb socket of a standard type. An arm 12 of the fixture holds a glass fitter in a fixed position surrounding a socket 16. Fitter 14 is preferably attached to arm 12 as shown in more detail in FIG. 2. In FIG. 1, a glass shade 18 can be positioned to rest inside fitter 14. Shade 18 has an enlarged lower opening 20 that fits over the socket 16. Shade 18 and fitter 14 preferably have been shaped so that the outer surface of shade 18 and the inner surface of shade 14 have approximately or exactly the same contour. This allows fitter 14 to retain shade 18 in position.

FIG. 2 illustrates details of attaching fitter 14. Arm 12 includes a shoulder 20 that supports fitter 14. An arm projection 22 extends beyond the shoulder 20, and is externally threaded. Fitter 14 has an opening 24 in the lower end thereof that fits over projection 22, but is smaller than shoulder 20. Lock nut 26 fits on the threads of projection 22, and holds fitter 14 firmly in place.

As shown, during manufacture, fitter 14 is attached to arm 12 before socket 16 is installed. Socket 16 has a diameter that is usually larger that the diameter of hole 26, so that the fitter 14 must be attached before socket 16 is installed. Thus, fitter 14 is not a part that is normally removable. If socket 16 is designed to be removable, fitter 14 can also be removed. However, this is not normally the case for lighting fixture designs. Commonly, one or more washers (not shown) will be provided to maintain fitter 14 in position. A rubber or other soft washer (not shown) may be included where fitter 14 contacts arm 12 to minimize breakage.

As previously described, fitter 14 is preferably made from glass or other material that differs from the material used to make arm 12 and the remainder of the fixture. Use of glass with a typical brass fixture provides a notable contrast that results in a very different look than that provided with a brass or other opaque fitter. If fitter 14 is clear or translucent, light from a bulb can pass through the fitter as well as shade 18, providing different illumination patterns than fixtures with opaque fitters. In addition, glass and similar materials can be cut or cast to forms difficult or impossible to achieve with an integral brass fitter, and can be finished with various mattes, colors, and other surface finishes to provide a pleasing look in connection with the fixture. The glass can be molded or cast to include a color or pattern selected to complement the fixture.

As previously described, the “glass” fitter can actually be made from other materials, such as acrylic or plastic. Formation of the fitter from materials different from those used for the remainder of the fixture give decorating styles that depart from the norm for brass and similar fixtures. The fixture designed is now provided with greater flexibility in designing new fixtures for sale and installation.

FIG. 3 illustrates details of a second embodiment of a fitter in accordance with the present invention. This design is useful in fixtures in which the shade does not simply rest on top of the fitter, and can be used as shown even of the fitter is above the shade. Fitter 14 is attached to arm 12 and shoulder 20 as previously described using a nut 26, and perhaps additional washers as needed and previously described. As before, fitter 14 is installed before a socket, because the opening 24 in fitter 14 is smaller than the socket.

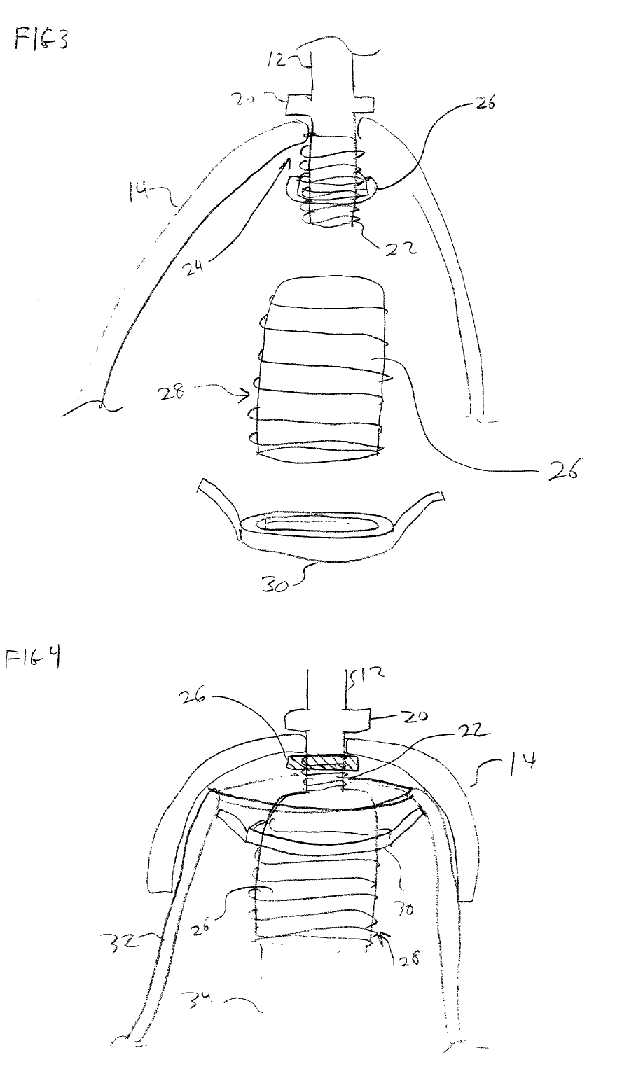

In this embodiment, a lamp socket 26 includes external threads 28 suitable for accepting a large nut 30. Once fitter 14 has been installed, socket 26 is attached. Thereafter, usually at the time the fixture is finally installed, a shade is provided and held in position by large but 30. This is illustrated in FIG. 4, showing shade 32 held in position against fitter 14 by large nut 30. In this embodiment, socket 26 and large nut 30 are preferably made from plastic having a hardness sufficient to support the shade 32 without any significant deformation.

Bulb 34 is installed after shade 32, and can easily be removed and replaced as in the prior art. Generally, shade 32 can only be removed without bulb 34 in position, because opening 36 at the base of shade 32 is only slightly larger that socket 26. Large nut 30 is appropriately sized to maintain shade 32 firmly in position against fitter 14. As previously described, the mating surfaces of fitter 14 and shade 32 are shaped to provide a close fit and help support shade 32 in position.

The described new fitter design allows significantly different decorating looks to be achieved in lighting fixtures because the fitter can be made to contrast with or complement the remainder of the fixture as desired. Use of glass or other materials allows the fitter to be transparent or translucent, and changes the lighting patterns provided by the fixture. In prior art fitters having opaque materials, light is blocked from passing through the fitter itself, but can pass through a glass fitter of the described design. Because the fitter is made from a different material, it must be installed after the remainder of the fixture is manufactured. This allows easy redesign of the fixture, using different fitters with the same brass remainder of the fixture.

While the invention has been particularly shown and described with reference to a preferred embodiment, it will be understood by those skilled in the art that various changes in form and detail may be made therein without departing from the spirit and scope of the invention.

What is claimed is:

1. An assembly for a lighting fixture, comprising:
a socket for receiving a light bulb;
a support arm connected to the socket and to the lighting fixture for supporting the socket in a fixed position;
a glass fitter attached to the support arm in a fixed relationship thereto; and
a shade held within the fitter, wherein the shade is removable.

2. The assembly of claim 1, wherein the shade rests inside the fitter and is held in place by gravity.

3. The assembly of claim 1, further comprising:
a threaded outer surface on the socket; and
a nut threaded onto the socket;
wherein the shade is held in place against the fitter by the nut.

4. The assembly of claim 3, wherein the shade has a base opening large enough to fit over the socket, and wherein the fitter has a base opening too small to fit over the socket.

5. The assembly of claim 1, wherein the shade has a base opening large enough to fit over the socket, and wherein the fitter has a base opening too small to fit over the socket.

6. The assembly of claim 1, wherein the fitter is transparent.

7. The assembly of claim 1, wherein the fitter is translucent.

8. The assembly of claim 1, wherein the fitter is molded.

9. An assembly for a lighting fixture, comprising:
a socket for receiving a light bulb;
a support arm connected to the socket and to the lighting fixture for supporting the socket in a fixed position, the support arm formed from a metal;
a fitter attached to the support arm in a fixed relationship thereto, the fitter formed from a non-metal material; and
a shade held within the fitter, wherein the shade is removable.

10. The assembly of claim 9, wherein the fitter comprises glass.

11. The assembly of claim 9, wherein the fitter comprises plastic.

12. The assembly of claim 9, wherein the fitter comprises acrylic.

13. The assembly of claim 9, wherein the support arm is formed form brass.

14. The assembly of claim 9, wherein the shade rests inside the fitter and is held in place by gravity.

15. The assembly of claim 9, further comprising:
a threaded outer surface on the socket; and
a nut threaded onto the socket;
wherein the shade is held in place against the fitter by the nut.

16. The assembly of claim 14, wherein the shade has a base opening large enough to fit over the socket, and wherein the fitter has a base opening too small to fit over the socket.

17. The assembly of claim 9, wherein the shade comprises glass.
